(19) United States
(12) Patent Application Publication
(10) Pub. No.: US 2011/0315245 A1
(43) Pub. Date: Dec. 29, 2011

(54) ANTI-LIGATURE FIXTURES

(75) Inventor: Alexandru Neagoe, Hockessin, DE (US)

(73) Assignee: SPEAKMAN COMPANY, New Castle, DE (US)

(21) Appl. No.: 12/826,127

(22) Filed: Jun. 29, 2010

(51) Int. Cl. F16K 21/00; B32B 1/00; B67D 7/84

(52) U.S. Cl. 137/560; 222/173; 428/174

(57) ABSTRACT

An anti-ligature fixture is provided to prevent the attachment of ligatures, thereby aiding in the prevention of suicide attempts by hanging. The fixture includes a sloped outer body and an inner body that extend above a surface. The fixture is affixed to the support surface such that there are no potential ligature points. The fixture is proportioned at specified critical angles and linear values and the inner body is formed such that components within the fixture do not protrude, thereby preventing potential ligature points. In one embodiment, the fixture is an anti-ligature dispenser with automatic dispensing means. In another embodiment, the fixture is an anti-ligature faucet with automatic discharge means.

### FIELD OF THE INVENTION

The present invention relates to anti-ligature fixtures, and more particularly to anti-ligature dispensers and anti-ligature faucets.

### BACKGROUND

Hanging is a common method of suicide worldwide. In the United States, it is ranked as a leading method used by persons attempting suicide. With this method of suicide, a person uses some form of ligature, e.g. shoe laces, electrical cords, belts, ropes, clothing, cables, etc., that is fixed both around the throat and at a ligature point. Ligature points are areas where a suicidal person can place a ligature to provide means for hanging.

Death by hanging is typically caused by strangulation, a broken neck, or a combination of these two causes. The actual cause of death depends upon the type of ligature used and the distance the person drops from the ligature point. However, full suspension from a ligature point is not required. Death by hanging can occur while a person is partially suspended or in kneeling, lying down, or seated positions.

Moreover, because a suicidal person can attempt to hang themselves using commonly available items, the use of anti-ligature devices and the removal of ligature points can assist with suicide prevention efforts. U.S. Pat. No. 7,024,823 to Keller, for example, provides a special door system designed to reduce suicide attempts and dimensioned to remove potential ligature points around doors and door frames in medical facilities.

Potential ligature points exist, however, in areas that are not so obvious. Fixtures, in particular, pose significant dangers to those contemplating suicide in both controlled environments like medical facilities, prisons, and psychiatric hospitals, and uncontrolled environments like private homes and public bathrooms. Moreover, bathroom fixtures pose additional danger because they are normally in areas where most people are afforded privacy.

Facilities that house those particularly at risk, e.g. the elderly, prisoners, and mentally impaired patients, recognize the key role of environment in preventing suicide. In fact, these facilities acknowledge that environmental deficiences are implicated in the majority of suicides that occur within these controlled environments. Patients and prisoners who attempt suicide frequently strangle themselves using some form of ligature while in fully or partially upright positions. These persons typically place ligatures on door hardware, sprinkler systems, shower hardware, shower curtain rods, bathroom fixtures, piping, and other areas that provide sufficient ligature points.

To prevent suicide by these methods, some facilities use “safe cells” that attempt to remove most means of hanging. These “safe cells,” however, primarily focus on ligature points on beds and doors where a person's full body weight is suspended. Unfortunately, lower areas within a cell or room are generally not considered in the design of these “safe cells.” Other facilities have implemented guidelines for facility design and construction that recommend anti-suicide products and sources. While useful for controlled environments, most of the products and sources are clearly for institutional use and are likely not suitable where the majority of suicides take place—the home.

Despite the methods and guidelines used by institutions and other facilities, the need to remove ligature points in fixtures has only recently been recognized. To date, only a few plumbing manufacturers specify anti-ligature fixtures. One type of fixture, as described in U.S. Pat. No. 7,631,655 to Kopp, uses a conical configuration for shower knobs that prevents noose or other ligature attachment. Other types of fixtures utilize recessed knobs or handles that require pushing or turning by hand. While useful for some aspects of suicide prevention, particularly in controlled environments, these fixtures lack pleasing aesthetics. In addition, because they require manual manipulation for operation, these fixtures are also unsanitary, containing potential areas for germ and staph accumulation. Moreover, these types of fixtures do not contemplate other ligature points to which a suicidal person may have access, e.g. underneath fixtures.

The prior art therefore lacks anti-ligature fixtures, and particularly anti-ligature dispensers and faucets, that are suitable for both home and institutional use. The art also presently lacks anti-ligature fixtures that are sanitary and aesthetically pleasing. In particular, there is a need for fixtures that do not require knob or handle manipulation and fixtures that limit piping and other dangerous components which may be accessible to persons contemplating suicide.

### SUMMARY OF THE INVENTION

The present invention is directed toward an anti-ligature fixture and, particularly, anti-ligature dispensers and anti-ligature faucets. The fixture includes a sloped outer body and an inner body that extend above a support surface. The fixture is affixed to the support surface such that there are no potential ligature points, thereby preventing the attachment of ligatures at such points.

Because of its unique shape and configuration, the anti-ligature fixture of this invention prevents the collection of germs on the fixture surface, as well as the attachment of ligatures. To prevent the collection of germs on the fixture surface, the anti-ligature fixture is designed with a smooth outer body such that crevices, where microbes and staphs can easily form, are limited. To prevent ligature attachment, the outer body is proportioned according to angles and linear values, as defined by specific formulae further described below. Further, in contrast to the shape and configuration of most fixtures, the inner body of the anti-ligature fixture is formed such that components within the fixture do not protrude, thereby preventing potential ligature points. Preferably, the sloped outer body and inner body are fixedly connected to each other such that the fixture is sanitary and aesthetically pleasing.

In one embodiment, the anti-ligature fixture is a dispenser that is affixed to a support surface with means for dispensing contents that channel through the fixture. Contents within the scope of the invention include fluids, for example, sanitizers, liquified soaps, and lotions, as well as particulate materials. The anti-ligature dispenser comprises a sloped outer body and an inner body attached to the outer body that are both configured to prevent the attachment of ligatures. The inner body has at least one outlet for dispensing fluids or particulates within or adjacent the fixture and a dispensing system fully or partially disposed within a cavity formed by the outer body and inner body, wherein the dispensing system has an automatic dispenser. Preferably, the automatic dispenser has a detection mechanism, like a sensor, which is known in the art for detecting the presence of hands or other objects. One such example of a sensor is described in U.S. Pat. No. 6,082,407 to Paterson et al., assigned to the Speakman Company, which is incorporated herein by reference in its entirety. When users place their hands near the sensor, contents within or adjacent the dispenser are discharged without the use of a knob or handle, allowing for improved sanitation and elimination of ligature points such as handles, pivoted push levers, and the like.

In another embodiment, the anti-ligature fixture is a faucet that is affixed to a support surface with means for controlling fluid supply. The fluid, however, is not limited to water supply. Other types of fluids are equally suitable for use with an anti-ligature faucet within the scope of the invention. Further, the support surface is not limited to a sink deck and may include any surface that is suitable for attachment.

Preferably, the anti-ligature faucet comprises a sloped outer body configured to prevent the attachment of ligatures, an inner body attached to the outer body having at least one outlet for fluid discharge, and a flow control system partially disposed within a cavity formed between the outer body and inner body, wherein the flow control system has an automatic dispenser. In this embodiment, the automatic means includes a sensor similar to that described in U.S. Pat. No. 6,082,407 to Paterson et al.

Additionally, an anti-ligature faucet embodying the principles of the invention can have the advantage of modularity such that the majority of faucet components are disposed above the surface. As further described in U.S. Pat. No. 7,445,025 to Paterson et. al, which is incorporated by reference in its entirety, modularity allows each element of the faucet to be separated, removed, replaced, or repaired without replacing the entire faucet or removing the faucet entirely from its mounting. This advantage limits the exposure of piping and other dangerous components, during repairs, to persons contemplating suicide.

Additional objectives and advantages of the invention will be obvious, in part, from the description, or may be learned by the practice of embodiments of the invention. Moreover, other aspects of the invention will become more readily apparent from the following drawings, detailed description, and appended claims.

### BRIEF DESCRIPTION OF THE DRAWINGS

The invention is further illustrated by the following drawings in which:

FIG. 1 is a perspective view of an anti-ligature fixture within the scope of the invention;

FIG. 2 is a front view of an anti-ligature fixture within the scope of the invention;

FIG. 3 is a side view of an anti-ligature fixture within the scope of the invention;

FIG. 4 is a perspective view of a sloped outer body for an anti-ligature fixture within the scope of the invention;

FIG. 5 is a perspective view of an inner body for an anti-ligature fixture within the scope of the invention;

FIG. 6 is a font view of an anti-ligature dispenser within the scope of the invention;

FIG. 7 is a cross sectional view as viewed along line 7-7 of the anti-ligature dispenser shown in FIG. 6;

FIG. 8 is a perspective view of an anti-ligature faucet within the scope of the invention;

FIG. 9 is a front elevational view of the anti-ligature faucet shown in FIG. 8;

FIG. 10 is a side elevational view of the anti-ligature faucet shown in FIG. 8;

FIG. 11 is a bottom elevational view of the anti-ligature faucet shown in FIG. 8; and

FIG. 12 is a cross sectional view as viewed along line 12-12 of the anti-ligature faucet shown in FIG. 9.

### DETAILED DESCRIPTION

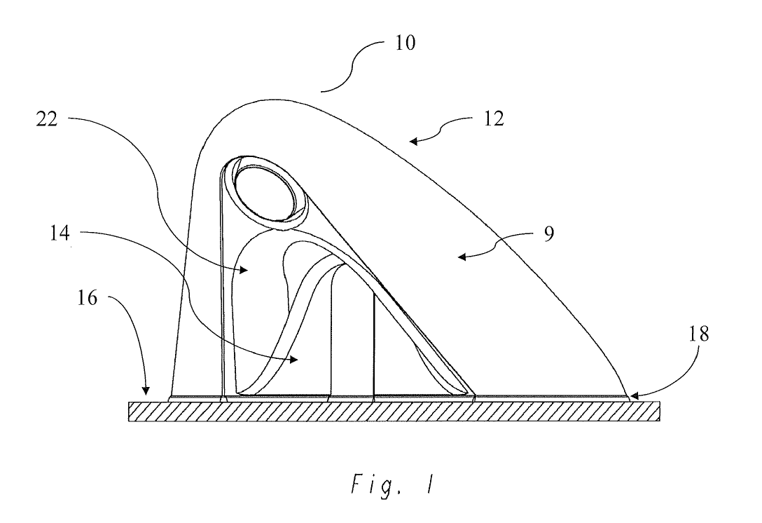

Turning in detail to the drawings, FIGS. 1-3 illustrate an anti-ligature fixture 10 embodying the principles of the invention. The anti-ligature fixture 10 is affixed to a support surface 16 and configured to prevent the collection of germs on the fixture surface and the attachment of ligatures.

A ligature is broadly defined to include any item that can be shaped into a cord-like object sufficient to cause harm to a living being. Ligatures are often placed by persons contemplating suicide at ligature points. A ligature point is also broadly defined to include any area capable of supporting a ligature that can cause harm to a living being. Commonly used ligatures that aid in strangulation, for example, include clothing, shoelaces, electrical wiring, blankets, sheets, ropes and cords.

An anti-ligature fixture 10 includes a sloped outer body 12 and an inner body 14 that both extend above a support surface 16. The fixture 10 has a smooth continuous outer surface 9 and is affixed to the support surface 16 such that there are no potential ligature points. The term “smooth continuous outer surface” is intended to mean a surface with a texture and finish such that there are no irregularities on which a ligature might be held. Inner body 14 is housed totally within and does not extend outwardly of outer body 12. As a result, only the outer surface of outer body 12 is readily accessible. The sloped outer body 12 and the inner body 14 are affixed to each other by any means sufficient to assure stability and prevent removal of the fixture 10 from the support surface 16. The fixture 10 can further comprise a base 18 that is affixed to the outer body 12, the inner body 14, and the support surface 16, by any attachment means. Preferably, a plurality of screws (not shown) rigidly connect the fixture 10 to a support surface 16. Examples of surfaces include, but are not limited to, kitchen sinks and vanity counters. The outer body 12, the inner body 14, and the base 18 can form a cavity 20 (not shown) to house additional components necessary for operation of the fixture 10. Examples of components within the scope of the invention include dispensing systems and flow control systems disposed fully or partially within the anti-ligature fixture 10.

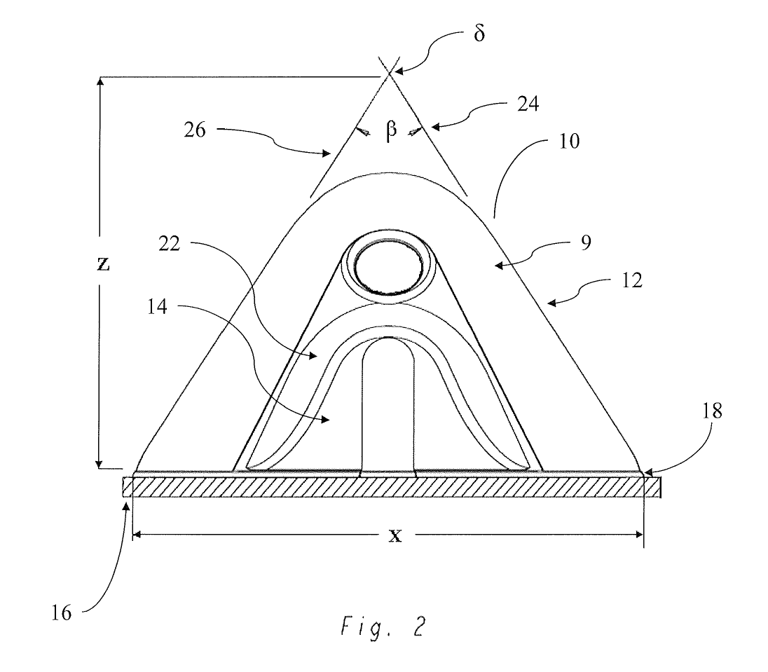

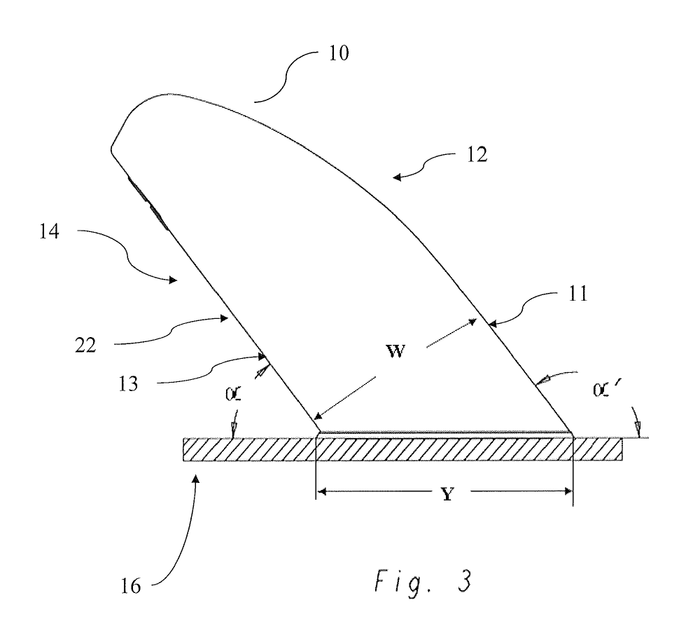

The outer body 12 is configured to prevent the attachment of ligatures. As shown in FIGS. 2 and 3, the outer body 12 is defined by the relationship of critical angles α, α′, β to the linear values of W, X, Y, and Z. As shown in FIG. 3, α is an angle with respect to inner edge 13 of inner body 14 and support surface 16 and α′ is an angle with respect to theoretical outer edge 11 of outer body 12 and support surface 16, as seen from the side view. Theoretical edges, as described herein, refer to edges of a curved surface, as seen from a specified view. As shown in FIG. 2, β is an angle with respect to a first theoretical edge 24 and a second theoretical edge 26, as seen from the front view of the fixture 10.

As further shown in FIG. 3, W is defined as the distance of the inner edge 13 of the inner body 14 to the theoretical outer edge 11 of the outer body 12, where the inner edge 13 and the outer edge 11 are substantially parallel. As shown in FIG. 2, X is defined as the width of the outer body 12 at the support surface 16, as seen from the front view of the fixture 10. Similarly, as shown in FIG. 3, Y is defined as the width of the outer body 12 at the support surface 16, as seen from the side view of the fixture 10. And, Z is the linear distance from the support surface 16 to a point δ, where δ is the point where theoretical edges 24 and 26 intersect. The outer body 12 is further oriented to the support surface 16 at angles α and α′. The angle α′ is the complimentary obtuse angle to the acute angle α.

With respect to the configuration of the anti-ligature fixture 10, the following formulae apply:

W=Y sine α

α=arcsine (W/Y);

α′=180°−arcsine (W/Y);

β=2 arctangent (X/2Z)

A fixture proportioned in accordance with this formulae results in an overall outer profile that aids in preventing the hanging of ligatures. Optimally, angles α′ and β are maximized such that the outer body has a “smooth continuous outer surface.” Accordingly, because α′=180°−arcsine (W/Y), distance W decreases while distance Y increases. Similarly, because β=2 arctangent (X/2Z), distance X increases, while distance Z decreases. Moreover, the dimensions of W, X, Y, and Z may, however, be limited by industry standards for particular fixtures, e.g. faucets affixed to sinks, and by the dimensions of components housed within the anti-ligature fixture.

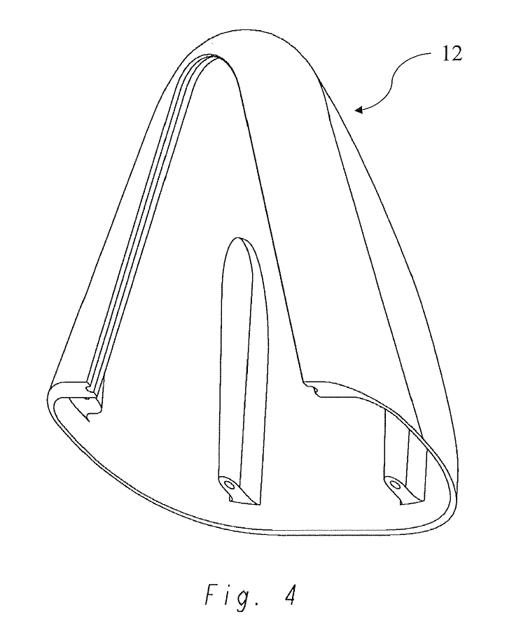

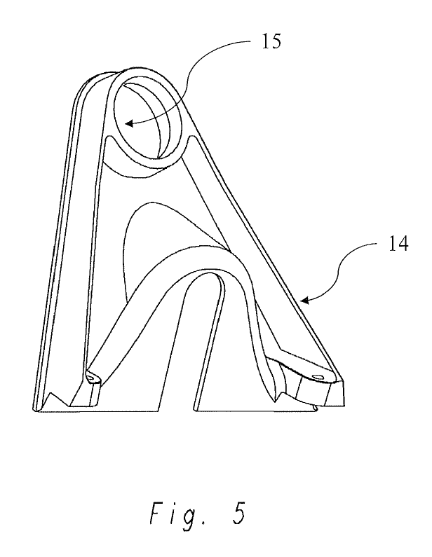

Preferably, the configuration also provides an extension of the fixture 10 at a distance suitable for dispensing functions, for example. An exemplary sloped outer body and an exemplary inner body, which includes an opening 15, are shown in FIGS. 4 and 5.

Additionally, the inner surface 22 of the inner body 14 is shaped to prevent the protrusion of components within the fixture 10. This configuration of the inner surface 22 also aids in preventing the attachment of ligatures to the fixture 10.

Preferably, the sloped outer body 12 and inner body 14 are constructed from durable materials which retain their shape and are dimensionally stable. Suitable materials include, but are not limited to, chrome plated zinc, polymer powder coated zinc, chrome plated brass, polymer powder coated brass, chrome plated acrylonitrile butadiene styrene (ABS) plastic, and various types of thermoplastics.

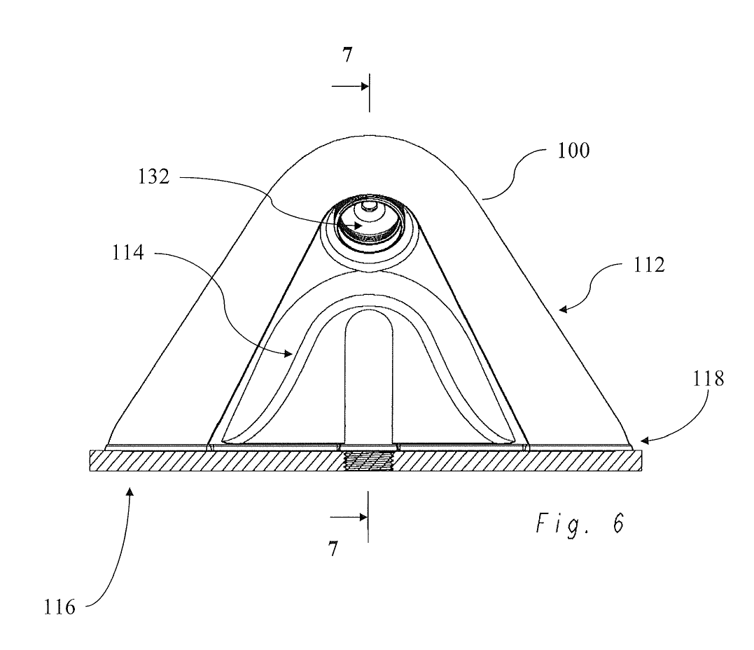

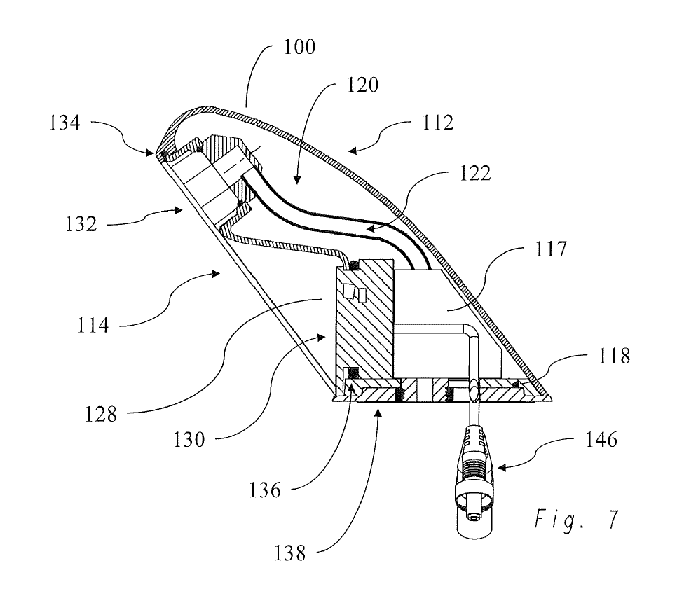

In one embodiment, as shown in FIGS. 6 and 7, the anti-ligature fixture 10 is configured as an anti-ligature dispenser 100 affixed to a support surface 116 (not shown in FIG. 7). The anti-ligature dispenser 100 comprises a sloped outer body 112 configured to prevent the attachment of ligatures, an inner body 114 attached to the outer body 112 having at least one outlet 132 for dispensing contents. The contents are disposed fully or partially within the dispenser 100. The dispenser 100 has a dispensing system 117, fully or partially disposed with the dispenser 100, that comprises at least a dispenser conduit 122 disposed within a cavity 120 formed by the outer body 112 and inner body 114, wherein an automatic dispenser mechanism 128 moves the contents to be dispensed through the dispenser conduit 122 to outlet 132.

Preferably, the dispensing system 117 includes an automatic dispenser mechanism 128 that is associated with a sensor 130 for detecting the presense of hands or other objects and for automatically dispensing the contents. The dispensing system 117 further comprises a power supply connector 146 and power supply (not shown) for the sensor 130. In addition, the anti-ligature dispenser 100 can further comprise a base 118 that is connected to the outer body 112 and the inner body 114. More preferably, the outer body 112 connects to the inner body 114 and the base 118, forming a sealed chamber. To achieve proper sealing, however, the dispenser 100 further comprises seals 134, 136, and 138.

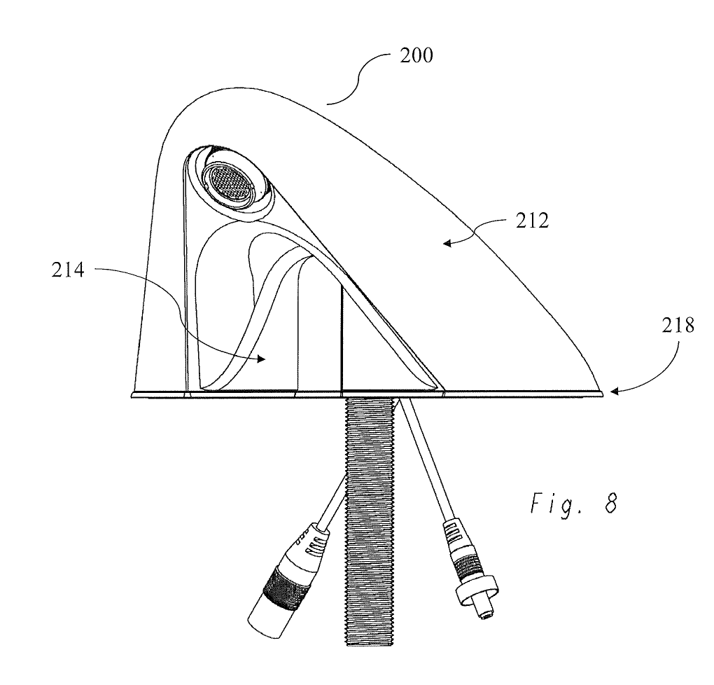

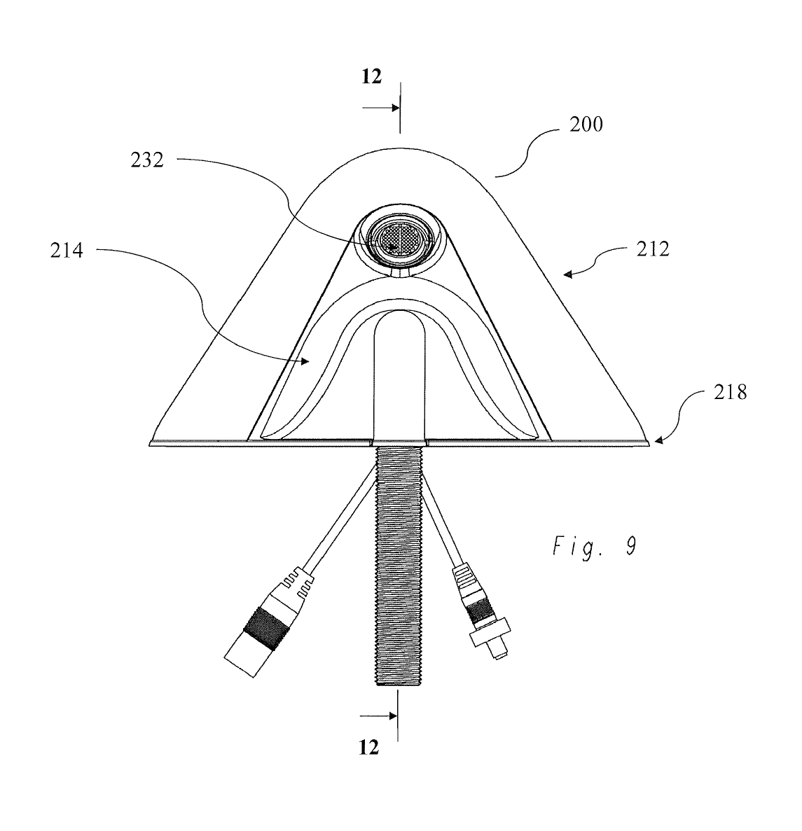

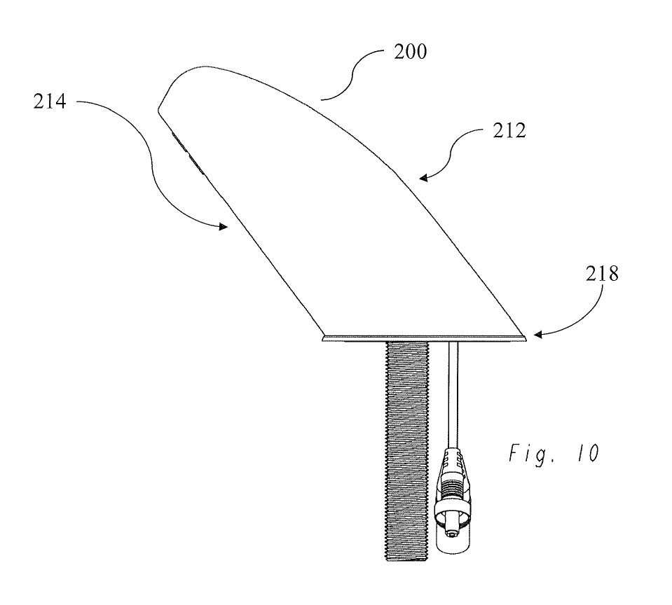

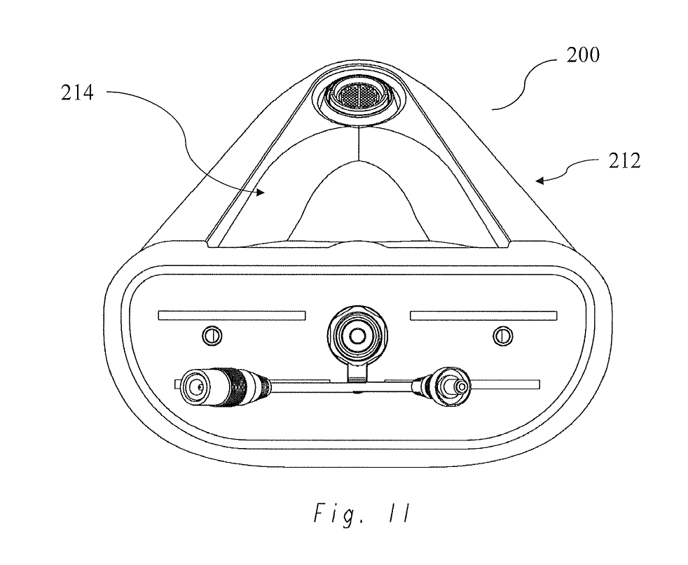

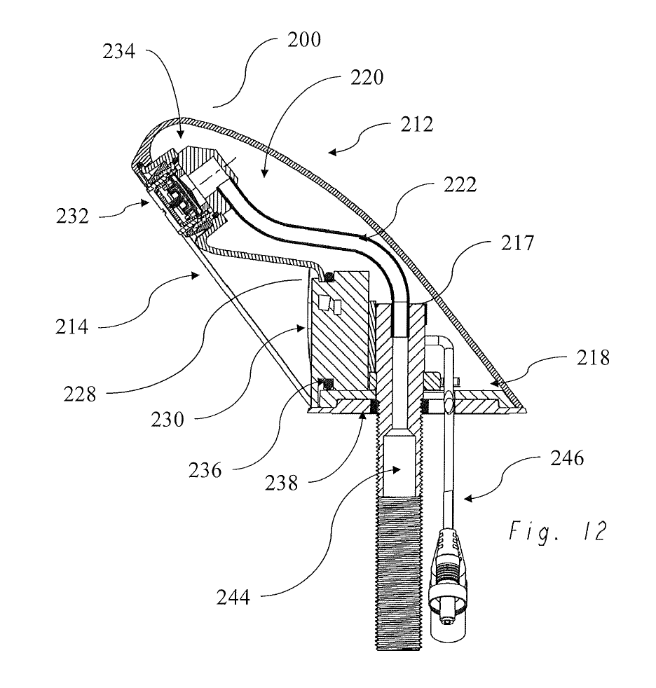

In another embodiment, as shown in FIGS. 8-12, the fixture 10 is an anti-ligature faucet 200 that is affixed to a support surface 216 (not shown). The faucet 200 comprises a sloped outer body 212 and an inner body 214 having a fluid discharge unit 232 for fluid discharge. The faucet 200 further comprises a flow control system 217 partially disposed within a cavity 220 formed by the outer body 212 and inner body 214. The flow control system 217 includes a sensor 230 (shown in FIG. 12) associated with an automatic discharge mechanism 228 which controls the flow of fluid from an inlet 244 through a fluid conduit 222 to a fluid discharge unit 232, as more fully described in U.S. Pat. No. 7,445,025. The faucet 200 can further comprise a base 218 that is connected to the outer body 212 and the inner body 214. The base 218 can be secured to a support surface 216 (not shown).

Preferably, the sensors are infrared, such as described in U.S. Pat. No. 6,082,407 to Paterson et al. The sensor 230 is also preferably set to activate a photosensor (not shown) and the faucet 200 when a user's hands are placed five to seven inches from the sensor 230. The flow control system 217 further comprises a power supply connector 246 and power supply (not shown) for the sensor 230.

As illustrated in FIG. 12, the fluid conduit 222 extends through the cavity 220 and connects to the fluid discharge unit 232 with a fluid supply 240 (not shown). When a user places his or her hands adjacent to the sensor 230 and under fluid discharge unit 232, the sensor 230 sends a signal to channel fluid flow from the inlet 244 and into the fluid conduit 222. The fluid flows through fluid conduit 222, exits the faucet 200 at fluid discharge unit 232, and flows over a user's hands. The fluid discharge unit 232 preferably has an aerator for fluid conservation and the reduction of splashing.

Preferably, the outer body 212 connects to the inner body 214 and the base 218, forming a sealed chamber. To achieve proper sealing, however, the faucet 200 further comprises seals 234, 236, and 238. As shown in FIG. 12, for example, a base seal 238 mounts between the support surface 216 and the base 218.

The faucet 200 may typically be operated at a pressure 70-80 psi, but may also be operated within a range from 15-150 psi.

Whereas particular embodiments of this invention have been described above for purposes of illustration, it will be evident to those skilled in the art that numerous variations of the details of the present invention may be made without departing from the invention, as defined in the appended claims.

What is claimed is:

1. An anti-ligature fixture affixed to a support surface comprising:
a sloped outer body having a smooth continuous outer surface configured to prevent attachment of a ligature; and
an inner body connected to the sloped outer body and configured to prevent attachment of a ligature, wherein the sloped outer body and the inner body extend above the support surface to form a cavity.

2. The anti-ligature fixture of claim 1, wherein the sloped outer body is proportioned according to a relationship of angles α, α′, and β to linear values W, X, Y, and Z.

3. The anti-ligature fixture of claim 2, wherein α, α′, β, and W are defined by formulae:
α=arcsine (W/Y);
α′=180°−arcsine (W/Y);
β=2 arctangent (X/2Z); and
W=Y sine α.

4. The anti-ligature fixture of claim 2, wherein:
α is an angle with respect to an inner edge of the inner body and the support surface;
α′ is an angle with respect to a theoretical outer edge of the outer body and the support surface;
β is an angle with respect to a first theoretical edge and a second theoretical edge of the outer body, from a front view of the fixture;
W is a distance from the inner edge of the inner body to a theoretical outer edge of the outer body, from a side view of the fixture;
X is a width of the outer body, from the front view of the fixture, defined at the support surface;
Y is a width of the outer body, from the side view of the fixture, defined at the support surface; and
Z is a linear distance from the support surface to a point δ, wherein δ is an intersection point of the first theoretical edge and the second theoretical edge, from the front view of the fixture.

5. The anti-ligature fixture of claim 4, wherein the theoretical outer edge and the inner edge are substantially parallel.

6. The anti-ligature fixture of claim 1, wherein the inner body is housed totally within the outer body.

7. The anti-ligature fixture of claim 1, further comprising a base connected to the sloped outer body and the inner body.

8. The anti-ligature fixture of claim 1, further comprising a dispensing system fully or partially disposed within the cavity formed by the sloped outer body and the inner body.

9. The anti-ligature fixture of claim 1, further comprising a flow control system fully or partially disposed within the cavity formed by the sloped outer body and the inner body.

10. An anti-ligature dispenser affixed to a support surface comprising:
a sloped outer body having a smooth continuous outer surface configured to prevent attachment of a ligature;
an inner body connected to the sloped outer body and configured to prevent attachment of a ligature, wherein the sloped outer body and the inner body extend above the support surface to form a cavity and wherein the inner body has at least one outlet for dispensing contents within or adjacent the dispenser;
and a dispensing system fully or partially disposed within the cavity.

11. The anti-ligature dispenser of claim 10, wherein the sloped outer body is proportioned according to a relationship of angles α, α′, and β to linear values W, X, Y, and Z.

12. The anti-ligature dispenser of claim 11, wherein α, α′, β, and W are defined by formulae:
α=arcsine (W/Y);
α′=180°−arcsine (W/Y);
β=2 arctangent (X/2Z); and
W=Y sine α.

13. The anti-ligature dispenser of claim 11, wherein:
α is an angle with respect to an inner edge of the inner body and the support surface;
α′ is an angle with respect to a theoretical outer edge of the outer body and the support surface;
β is an angle with respect to a first theoretical edge and a second theoretical edge of the outer body, from a front view of the dispenser;
W is a distance from the inner edge of the inner body to a theoretical outer edge of the outer body, from a side view of the dispenser;
X is a width of the outer body, from the front view of the dispenser, defined at the support surface;
Y is a width of the outer body, from the side view of the dispenser, defined at the support surface; and
Z is a linear distance from the support surface to a point δ, wherein δ is an intersection point of the first theoretical edge and the second theoretical edge, from the front view of the dispenser.

14. The anti-ligature dispenser of claim 13, wherein the theoretical outer edge and the inner edge are substantially parallel.

15. The anti-ligature dispenser of claim 10, wherein the inner body is housed totally within the outer body.

16. The anti-ligature dispenser of claim 10, wherein the dispensing system has an automatic dispenser mechanism.

17. The anti-ligature dispenser of claim 10, further comprising a base connected to the sloped outer body and the inner body.

18. The anti-ligature dispenser of claim 10, wherein the dispensing system includes a sensor that provides an automatic means for dispensing contents within or adjacent to the dispenser.

19. An anti-ligature faucet affixed to a support surface comprising:
a sloped outer body having a smooth continuous outer surface configured to prevent attachment of a ligature,
an inner body connected to the sloped outer body and configured to prevent attachment of a ligature, wherein the sloped outer body and the inner body extend above the support surface to form a cavity and wherein the inner body has at least one opening for fluid discharge,
and a flow control system to regulate fluid discharge partially disposed within the cavity.

20. The anti-ligature faucet of claim 19, wherein the sloped outer body is proportioned according to a relationship of angles α, α′, and β to linear values W, X, Y, and Z.

21. The anti-ligature faucet of claim 20, wherein α, α′, β, and W are defined by formulae:
α=arcsine (W/Y);
α′=180°−arcsine (W/Y);
β=2 arctangent (X/2Z); and
W=Y sine α.

22. The anti-ligature faucet of claim 20, wherein:
α is an angle with respect to an inner edge of the inner body and the support surface;
α′ is an angle with respect to a theoretical outer edge of the outer body and the support surface;
β is an angle with respect to a first theoretical edge and a second theoretical edge of the outer body, from a front view of the faucet;
W is a distance from the inner edge of the inner body to a theoretical outer edge of the outer body, from a side view of the faucet;
X is a width of the outer body, from the front view of the faucet, defined at the support surface;
Y is a width of the outer body, from the side view of the faucet, defined at the support surface; and
Z is a linear distance from the support surface to a point δ, wherein δ is an intersection point of the first theoretical edge and the second theoretical edge, from the front view of the faucet.

23. The anti-ligature faucet of claim 22, wherein the theoretical outer edge and the inner edge are substantially parallel.

24. The anti-ligature faucet of claim 19, wherein the flow control system includes a sensor that provides an automatic means for fluid discharge.

25. The anti-ligature faucet of claim 19, further comprising a base connected to the sloped outer body and the inner body.
